(19) United States
(12) Patent Application Publication
(10) Pub. No.: US 2019/0130003 A1
(43) Pub. Date: May 2, 2019

(54) SYSTEM AND METHOD FOR MONITORING DATACENTER COMPONENTS USING SUBQUERIES

(71) Applicant: Nutanix, Inc., San Jose, CA (US)

(72) Inventors: Atreyee Maiti, San Jose, CA (US); Himanshu Shukla, San Jose, CA (US); Piyush Nimbalkar, San Jose, CA (US); Rahul Singh, San Jose, CA (US); Ranjan Parthasarathy, San Jose, CA (US); Ziv Kennan, San Jose, CA (US)

(21) Appl. No.: 15/799,080

(22) Filed: Oct. 31, 2017

(51) Int. Cl. G06F 17/30; G06F 9/455

(52) U.S. Cl. CPC G06F 17/30483; G06F 17/30554; G06F 2009/45591; G06F 9/45558; G06F 17/30427

(57) ABSTRACT

A system and method include receiving, by a virtual computing system, a search query via a search interface of a search computing system, converting the search query into a primary structured query that identifies a primary entity within the virtual computing system and an activity type associated with the primary entity. The system and method also include generating a subquery from the primary structured query, including associating the activity type of the primary entity with the subquery, such that the subquery identifies a related entity of the primary entity, generating search results from the primary entity and the related entity corresponding to the activity type included in the primary structured query and the subquery, and displaying the search results on the search interface for monitoring components of a datacenter.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, present day virtual computing systems still have limitations due to their configuration and the way they operate.

### SUMMARY

In accordance with at least some aspects of the present disclosure, a method is disclosed. The method comprises receiving, by a virtual computing system, a search query via a search interface of a search computing system, converting, by the virtual computing system, the search query into a primary structured query that identifies a primary entity within the virtual computing system and an activity type associated with the primary entity, and generating, by the virtual computing system, a subquery from the primary structured query, including associating the activity type of the primary entity with the subquery. The subquery identifies a related entity of the primary entity. The method also includes generating, by the virtual computing system, search results from the primary entity and the related entity corresponding to the activity type included in the primary structured query and the subquery, and displaying, by the virtual computing system, the search results on the search interface for monitoring components of a datacenter.

In accordance with some other aspects of the present disclosure, a search system is disclosed. The search system includes a subquery search system of a virtual computing system. The subquery search system includes a subquery database configured to store a subquery generated by the subquery search system and a subquery processing unit. The subquery processing unit is configured to identify a primary entity from a primary structured query. The primary structured query is generated by the search system from a search query received via a search interface. The subquery processing unit is further configured to identify an activity type from the primary structured query, determine a related entity of the primary entity, generate the subquery from the related entity and the activity type, and store the subquery within the subquery database. The subquery processing unit is also configured to generate related search results from the subquery.

In accordance with some other aspects of the present disclosure, a method is disclosed. The method includes receiving, by a subquery search system of a virtual computing system, a primary structured query from a primary search system, identifying, by the subquery search system, a primary entity and an activity type from the primary structured query, and determining, by the subquery search system, a related entity of the primary entity. The method also includes generating a subquery from the related entity, including associating the activity type with the related entity in the subquery, generating, by the subquery search system, related search results based upon the subquery, and transmitting, by the subquery search system, the related search results for displaying on a search interface.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2 is a block diagram of a search computing system of the virtual computing system of FIG. 1, the search computing system including a primary search system and a subquery search system, in accordance with some embodiments of the present disclosure.

FIG. 3 is block diagram of the subquery search system of FIG. 2, in accordance with some embodiments of the present disclosure.

FIG. 4 is a first example of an entity relationship graph, in accordance with some embodiments of the present disclosure.

FIG. 5 is a second example of the entity relationship graph, in accordance with some embodiments of the present disclosure.

FIG. 6 is a third example of the entity relationship graph, in accordance with some embodiments of the present disclosure.

FIG. 7 is an example flowchart outlining operations for generating related search results using the subquery search system, in accordance with some embodiments of the present disclosure

FIG. 8 is an example flowchart outlining a search operation, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to monitoring various components of a datacenter via a search operation using a search computing system. The search computing system is associated with a virtual computing system, components of which are part of the datacenter. Thus, the present disclosure provides a simple, convenient, and efficient mechanism of searching for various features of the components of the datacenter using the search computing system.

The search computing system includes a primary search system and a subquery search system. The primary search system is configured to generate primary search results based on a search query run by a user. The subquery search system is configured to use information from the primary search system and generate related search results. The primary search results are based upon a primary entity. The related search results are based upon entities that are related to the primary entity. The primary entity and the entities related to the primary entity are components of the virtual computing system, and therefore, of the datacenter. Thus, by running a simple search query via the search computing system, the user may obtain relevant information pertaining to components that the user may have searched for, as well as information from components that the user may not have searched for but which may be relevant for the user. Thus, the search computing system attempts to predict the intent of the user in running the search query and returns search results to the user based upon the identified intent.

Further, the entities (e.g., components) within the virtual computing system are connected to one another, either directly or indirectly. Thus, the entities may impact one another. For example, problems occurring at one entity within the virtual computing system may impact the performance of another related entity. Likewise, problems occurring at one entity may be caused from problems at another entity. By gathering search results from not only the primary entity, but also from the entities related to the primary entity, information that may be valuable to the user and that may provide clues into problems occurring at a particular entity may be easily and conveniently provided. Thus, the user may be able to easily and efficiently identify the root cause of certain issues that may be impacting certain components within the datacenter. Further, the user may be able to uncover problems that the user may not otherwise be aware of and proactively address the problem.

Therefore, together, the primary search results and the related search results improve the relevancy, accuracy, and effectiveness of a search operation, as well as enable convenient monitoring of the components within the datacenter. With a single search query, a user may be able to obtain search results that otherwise may have required multiple search queries. Thus, relevant search results may be obtained faster.

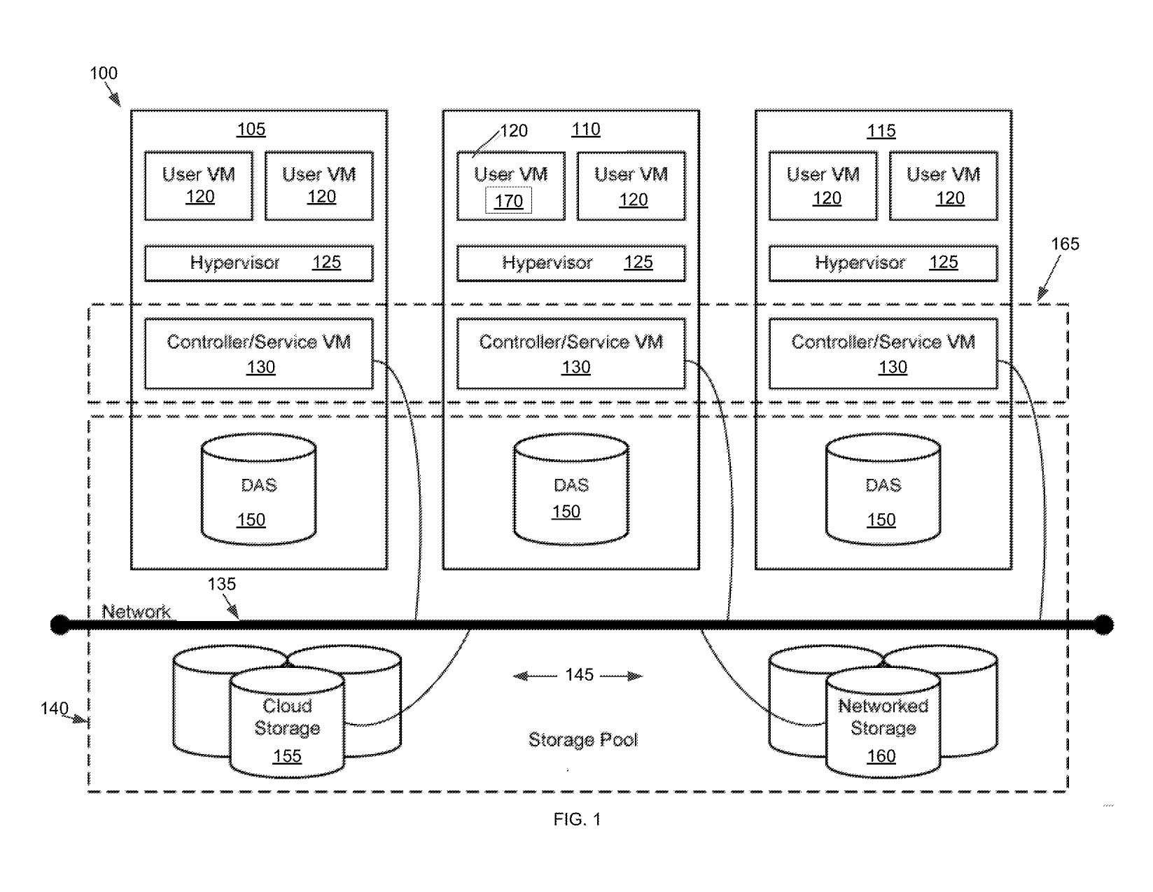

Referring now to FIG. 1, a virtual computing system 100 is shown, in accordance with some embodiments of the present disclosure. The virtual computing system 100 may be part of a datacenter. The virtual computing system 100 includes a plurality of nodes, such as a first node 105, a second node 110, and a third node 115. Each of the first node 105, the second node 110, and the third node 115 includes user virtual machines (VMs) 120 and a hypervisor 125 configured to create and run the user VMs. Each of the first node 105, the second node 110, and the third node 115 also includes a controller/service VM 130 that is configured to manage, route, and otherwise handle workflow requests to and from the user VMs 120 of a particular node. The controller/service VM 130 is connected to a network 135 to facilitate communication between the first node 105, the second node 110, and the third node 115. Although not shown, in some embodiments, the hypervisor 125 may also be connected to the network 135.

The virtual computing system 100 may also include a storage pool 140. The storage pool 140 may include network-attached storage 145 and direct-attached storage 150. The network-attached storage 145 may be accessible via the network 135 and, in some embodiments, may include cloud storage 155, as well as local storage area network 160. In contrast to the network-attached storage 145, which is accessible via the network 135, the direct-attached storage 150 may include storage components that are provided within each of the first node 105, the second node 110, and the third node 115, such that each of the first, second, and third nodes may access its respective direct-attached storage without having to access the network 135.

It is to be understood that only certain components of the virtual computing system 100 are shown in FIG. 1. Nevertheless, several other components that are commonly provided or desired in a virtual computing system are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater or fewer than three nodes may be used. Likewise, although only two of the user VMs 120 are shown on each of the first node 105, the second node 110, and the third node 115, in other embodiments, the number of the user VMs on the first, second, and third nodes may vary to include either a single user VM or more than two user VMs. Further, the first node 105, the second node 110, and the third node 115 need not always have the same number of the user VMs 120. Additionally, more than a single instance of the hypervisor 125 and/or the controller/service VM 130 may be provided on the first node 105, the second node 110, and/or the third node 115.

Further, in some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100.

Each of the first node 105, the second node 110, and the third node 115 may also be configured to communicate and share resources with each other via the network 135. For example, in some embodiments, the first node 105, the second node 110, and the third node 115 may communicate and share resources with each other via the controller/service VM 130 and/or the hypervisor 125. One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 140, as well as with other elements of the respective first node 105, the second node 110, and the third node 115 to receive, send, and process information, and to control the operations of the underlying first, second, or third node. The processing units may retrieve a set of instructions from the storage pool 140, such as, from a permanent memory device like a read only memory (ROM) device and copy the instructions in an executable form to a temporary memory device that is generally some form of random access memory (RAM). The ROM and RAM may both be part of the storage pool 140, or in some embodiments, may be separately provisioned from the storage pool. Further, the processing units may include a single stand-alone processing unit, or a plurality of processing units that use the same or different processing technology.

With respect to the storage pool 140 and particularly with respect to the direct-attached storage 150, it may include a variety of types of memory devices. For example, in some embodiments, the direct-attached storage 150 may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 145 may include any of a variety of network accessible storage (e.g., the cloud storage 155, the local storage area network 160, etc.) that is suitable for use within the virtual computing system 100 and accessible via the network 135. The storage pool 140 including the network-attached storage 145 and the direct-attached storage 150 may together form a distributed storage system configured to be accessed by each of the first node 105, the second node 110, and the third node 115 via the network 135 and the controller/service VM 130, and/or the hypervisor 125. In some embodiments, the various storage components in the storage pool 140 may be configured as virtual disks for access by the user VMs 120.

Each of the user VMs 120 is a software-based implementation of a computing machine in the virtual computing system 100. The user VMs 120 emulate the functionality of a physical computer. Specifically, the hardware resources, such as processing unit, memory, storage, etc., of the underlying computer (e.g., the first node 105, the second node 110, and the third node 115) are virtualized or transformed by the hypervisor 125 into the underlying support for each of the plurality of user VMs 120 that may run its own operating system and applications on the underlying physical resources just like a real computer. By encapsulating an entire machine, including CPU, memory, operating system, storage devices, and network devices, the user VMs 120 are compatible with most standard operating systems (e.g. Windows, Linux, etc.), applications, and device drivers. Thus, the hypervisor 125 is a virtual machine monitor that allows a single physical server computer (e.g., the first node 105, the second node 110, third node 115) to run multiple instances of the user VMs 120, with each user VM sharing the resources of that one physical server computer, potentially across multiple environments. By running the plurality of user VMs 120 on each of the first node 105, the second node 110, and the third node 115, multiple workloads and multiple operating systems may be run on a single piece of underlying hardware computer (e.g., the first node, the second node, and the third node) to increase resource utilization and manage workflow.

The user VMs 120 are controlled and managed by the controller/service VM 130. The controller/service VM 130 of each of the first node 105, the second node 110, and the third node 115 is configured to communicate with each other via the network 135 to form a distributed system 165. The hypervisor 125 of each of the first node 105, the second node 110, and the third node 115 may be configured to run virtualization software, such as, ESXi from VMWare, AHV from Nutanix, Inc., XenServer from Citrix Systems, Inc., etc., for running the user VMs 120 and for managing the interactions between the user VMs and the underlying hardware of the first node 105, the second node 110, and the third node 115. The controller/service VM 130 and the hypervisor 125 may be configured as suitable for use within the virtual computing system 100.

The network 135 may include any of a variety of wired or wireless network channels that may be suitable for use within the virtual computing system 100. For example, in some embodiments, the network 135 may include wired connections, such as an Ethernet connection, one or more twisted pair wires, coaxial cables, fiber optic cables, etc. In other embodiments, the network 135 may include wireless connections, such as microwaves, infrared waves, radio waves, spread spectrum technologies, satellites, etc. The network 135 may also be configured to communicate with another device using cellular networks, local area networks, wide area networks, the Internet, etc. In some embodiments, the network 135 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 140 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120 that are part of a cluster may be configured to share resources with each other.

Further, as shown herein, one or more of the user VMs 120 may be configured to have a search computing system 170. In some embodiments, the search computing system 170 may be provided on one or more of the user VMs 120 of the leader node, while in other embodiments, the search computing system 170 may be provided on another node. In some embodiments, the search computing system 170 may be provided on a user virtual machine that is separate from but associated with the user VMs 120. For example, in some embodiments, the search computing system 170 may be provided on a user virtual machine that is configured to manage the various clusters and elements within the various clusters of the virtual computing system 100. In some embodiments, the search computing system 170 may reside on the controller/service VM 130. Thus, the search computing system 170 may be configured to reside on a variety of components within the virtual computing system 100 as desired.

The search computing system 170 may be configured to access the resources (e.g., storage, processing unit, etc.) of at least the user VM on which the search computing system is installed. Although the search computing system 170 has been shown in FIG. 1 as being provided on one of the user VMs 120, in some embodiments, the search computing system may be provided on multiple user VMs. In yet other embodiments, the search computing system 170 may be provided on a computing machine that is outside of the first node 105, the second node 110, and the third node 115, but connected to those nodes in operational association. In some such embodiments, the computing machine on which the search computing system 170 is provided may be either within the virtual computing system 100 or outside of the virtual computing system and operationally associated therewith. Generally speaking, the search computing system 170 may be connected to for receiving data from one or more clusters within the virtual computing system 100. Thus, either a single instance of the search computing system 170 or multiple instances of the search computing system, with each search computing system instance being connected to one or more clusters may be provided.

Furthermore, the search computing system 170 may be used to receive search queries from a user and provide results back to the user in response to the received search queries. The search results may correspond to data received back from the components of the cluster(s) that are connected to and communicating with the search computing system 170. Additional details of the search computing system are provided in U.S. application Ser. No. 15/143,060, filed on Apr. 29, 2016, the entirety of which is incorporated by reference herein.

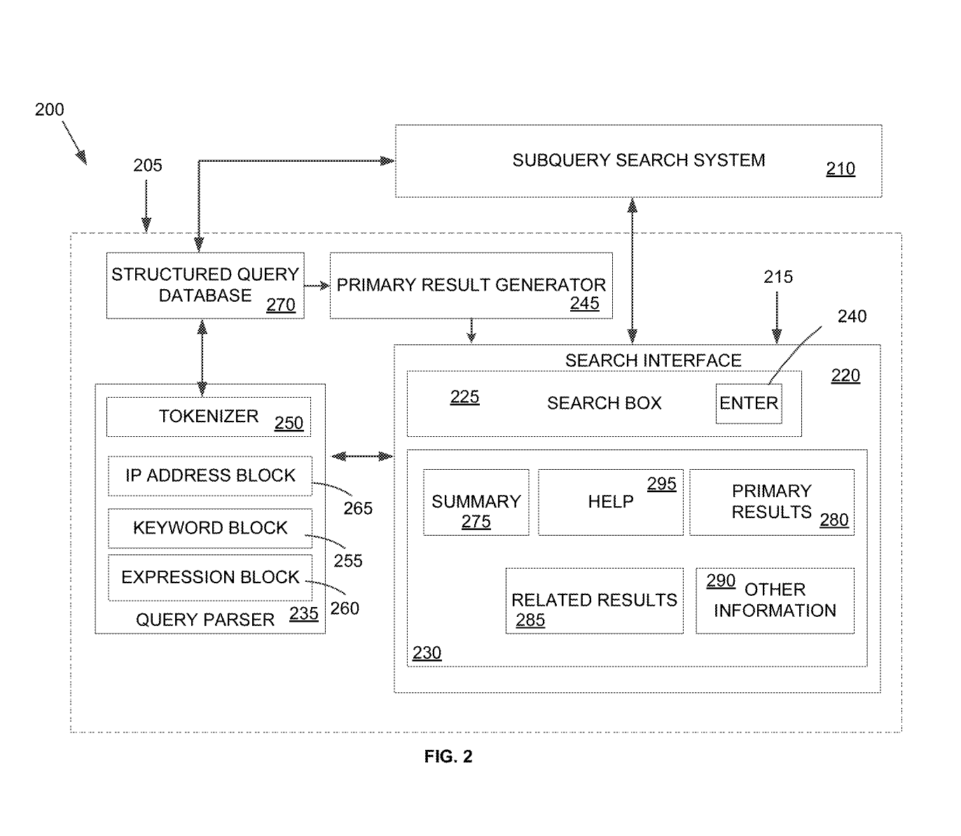

Turning to FIG. 2, a search computing system 200 is shown, in accordance with some embodiments of the present disclosure. The search computing system 200 is configured to receive search queries from the user and provide search results back to the user. The search computing system 200 is a contextual search system that identifies the context of a search query and particularly, identifies the intent of the user in running the search query. The search computing system 200 may identify the intent of the user by analyzing the search query, as detailed below, to determine whether the user is in a troubleshooting mode, exploration mode, a management mode, or another type of work flow mode. The search computing system 200 may return results back based upon the identified intent of the user.

The search computing system includes a primary search system 205 and a subquery search system 210. The primary search system 205 returns primary search results based upon search queries run by the user. The subquery search system 210 returns related search results based upon the search queries run by the user. Thus, for each search query run by the user, primary search results and related search results are returned to the user, both of which are explained in greater detail below. By virtue of augmenting the primary search results with the related search results, the overall search functionality of the search computing system 200 is improved. Specifically, more relevant results may be returned to the user and components of the virtual computing system 100 that may otherwise not have been accessed for obtaining the primary search results may now be accessed using the subquery search system 210. Accordingly, searches are performed more effectively and efficiently.

In some embodiments, the primary search results and the related search results may be combined together to generate combined search results and the combined search results may be returned to the user. In other embodiments, the primary search results and the related search results may be returned separately to the user without combining. In yet other embodiments, combined search results, as well as either or both of the primary search results and the related search results may be returned to the user. Also, in some embodiments, the user may be given the ability to configure the search computing system 200 and identify the manner in which to receive the search results (e.g., whether to receive the combined search results, separate primary and related search results, or a combination of both).

Additionally, in some embodiments, either or both of the primary search results and the related search results may be ranked according to one or more criteria before the results are returned to the user. In some embodiments, when the primary and the related search results are combined, the combined search results may be ranked according to one or more criteria to obtain a global overall ranking. Thus, as needed, the primary search results, the related search results, and/or the combined search results may be ranked. Further, the criteria that is used to rank the primary search results, the related search results, and/or the combined search results may be different for each type of search result. The criteria that is used for ranking may be system defined, user defined, or a combination of both. The criteria may be chronological, alphabetical, numerical, relevance, or any other ranking criteria that may be considered desirable. In some embodiments, the ranking criteria may be based on an indication of criticality. For example, if certain search results (e.g., alerts) are indicated as being high priority or critical, those search results may be ranked higher than other search results. Other or additional ranking criteria may be used in other embodiments.

The primary search system 205 includes a search interface 215 that is configured to receive the search queries from the user and return the search results back to the user. The search interface 215 includes a user interface 220 having a search box 225 for receiving search queries from the user and a search display box 230 for displaying the corresponding search results. In some embodiments, the search display box 230 may be configured to display the primary search results, the related search results, as well as the combined search results if the primary search results and the related search results are combined. For example, in other embodiments, separate search display boxes may be provided within the user interface 220 for displaying each category (e.g., the primary, related, and combined) of search results. In other embodiments, the search display box 230 may be configured such that on a single search display box, all of the categories of search results are displayed, but only one at a time. Thus, the search display box 230 may be configured in a variety of ways as desired. Additional details of the search display box 230 are discussed below.

Thus, the user interface 220 is configured to receive information from and provide information back to the user. The user interface 220 may be any suitable user interface. For example, the user interface 220 may be an interface for receiving user input and/or machine instructions for entry into the search box 225. The user interface 220 may use various input technologies including, but not limited to, a keyboard, a stylus and/or touch screen, a mouse, a track ball, a keypad, a microphone, voice recognition, motion recognition, disk drives, remote controllers, input ports, one or more buttons, dials, joysticks, etc. to allow an external source, such as the user, to enter information into the search box 225.

The user interface 220 may also be configured for presenting information from the search computing system 200 to external systems, users, memory, etc. For example, the user interface 220 may display the search results within the search display box 230. Alternatively or additionally, the user interface 220 may include an interface for a printer, speaker, alarm/indicator lights, etc. to provide the search results. The user interface 220 may be provided on a color display, a cathode-ray tube (CRT), a liquid crystal display (LCD), a plasma display, an organic light-emitting diode (OLED) display, etc. Further, only certain features of the user interface 220 are shown herein. Nevertheless, in other embodiments, other features that are commonly provided on user interfaces and particularly, on user interfaces used in a virtualization environment (e.g., the virtual computing system 100) may be provided. For example, in some embodiments, the user interface 220 may include navigational menus, adjustment options, adjustment settings, adjustment display settings, etc. The user interface 220 may be configured to send information to and receive information from a query parser 235 and any additional components within the virtual computing system 100 that are deemed desirable to communicate with the search interface 215.

The user inputs a search query into the search box 225 and interacts with (e.g., click, press-and-hold, roll or hover over, etc.) a search button 240 to send the search query to the query parser 235 for further processing and retrieval of search results. The search interface 215 and particularly, the search box 225, may be configured to receive and recognize a variety of configurations of the search query. For example, in some embodiments, the user may input the search query in the form of keywords. Keywords are pre-defined terms or phrases that are understood by the search computing system 200. A list of all keywords understood by the search computing system 200 may be stored within a database that is accessible to the search computing system. The list of keywords may also be made available to the user.

Each keyword may be classified into one or more of four categories: entity type, properties, identifiers, and actions. “Entity type” keywords may include the different types of entities, such as, clusters, nodes, virtual machines, virtual disks, software applications, and other hardware, software, storage, virtual clouds, and data center components that make up the virtual computing system 100. Each “entity type” may include one or more “entities.” For example, in FIG. 1, each of the first node 105, the second node 110, and the third node 115 is an “entity” of “entity type” host machine.

“Properties” keywords include various attributes, values of attributes, and metrics/metric names associated with each entity type and/or entity. For example, each entity type may include one or more “properties” that may be same as, similar to, or different from the “properties” of the other entity types. In some embodiments, all of the entities included within a specific entity type may have the same properties. In other embodiments, the entities for a specific entity type may have at least some varying properties. Examples of “properties” keywords may include attributes such as type of operating system, number of processing units, number of storage units, IP address, etc. As noted above, “properties” keywords also include various metrics, such as processing unit utilization, disk space, latency, etc. Thus, the “properties” keywords identify the various hardware, software, and firmware features and characteristics of each entity and entity type.

“Identifiers” keywords may include identification information that may be used to uniquely identify an entity and/or entity type. For example, the “identifiers” keywords may include entity name (e.g., host name, cluster name, etc.), entity version, or any other identifying information that may be used to uniquely identify and distinguish one entity and/or entity type from another entity and/or entity type within a cluster.

“Actions” keywords include any actions that a particular entity and/or entity type may be authorized to perform. For example, “actions” keywords may include create, modify, delete, add, etc. that an entity and/or entity type may perform. The “actions” keywords may also include various work flow related tasks such as data recovery, capacity management, etc. that an entity and/or entity type may perform.

In addition to simple keywords, in some embodiments, the user may enter the search query in the form of an expression. Expressions may include phrases or keywords that are separated by an operator. The operator may be a symbol (e.g., =, >, <, etc.) or a subjective keyword (e.g., slow, high, low, top, greater than, less than, equal to, etc.). In some embodiments, the operator may also include advanced filter values (e.g., contains, does not contain, etc.). A valid expression includes a left hand side term and a right hand side term separated by the operator. In some embodiments, the left hand side term may be a keyword or a commonly used, “human friendly,” word. The right hand side term may be a value of the left hand side term. For example, an expression could be “version=5.0.” In this example, the left hand side term, “version,” may be a recognized keyword (or a commonly used term that may be translated into a recognized keyword by the search computing system 200) and the right hand side term, “5.0,” is a value of the left hand side term, “version.” Similar to the keywords, a list of all recognized operators may be stored within a database and be accessible to the search computing system 200.

In some other embodiments, the user may enter an Internet Protocol (IP) address as the search query. In yet other embodiments, the user may simply use “human friendly” words to construct the search query, which may then be translated by the query parser 235 into recognized keywords. Thus, the user may enter the search query in the form of keywords, expressions, IP addresses, “human-friendly” terms, or a combination thereof. The search interface 215 may also provide other features in the search box 225. For example, in some embodiments, the search box 225 may have an auto-complete feature, such that as the user is inputting (e.g., typing) the search query, the search interface suggests options to complete the query. The search box 225 may also suggest synonyms, alternate terms, and/or keywords that the user may use as part of the search query. Additional features of the search query are described in the U.S. application Ser. No. 15/143,060 mentioned above.

The search query entered into the search box 225 is sent to the query parser 235. The query parser 235 parses the search query, converts the parsed search query into a primary structured query, and facilitates retrieval and compilation of the primary search results in a primary result generator 245. To facilitate parsing of the search query and converting into a primary structured query, the query parser 235 includes a tokenizer 250, a keyword block 255, an expression block 260, and an IP address block 265. The keyword block 255 stores a list of all keywords that are recognized by the search computing system 200. Similarly, the expression block 260 stores a list of all recognized expressions, while the IP address block 265 stores a list of all recognized IP addresses. Although shown as separate components, in other embodiments, one or more of the keyword block 255, the expression block 260, and the IP address block 265 may be combined together. Further, one or more of the keyword block 255, the expression block 260, and the IP address block 265 may be stored within or be provisioned from the storage pool 140. In other embodiments, one or more of the keyword block 255, the expression block 260, and the IP address block 265 may be part of a database that is separate from the storage pool 140 but accessible to the search computing system 200.

Also, in some embodiments, the query parser 235 may include a correlation block (not shown) for converting any “human-friendly” words in the search query into recognized keywords, expressions, and/or IP addresses. In some embodiments, the correlation block may be part of one or more of the keyword block 255, the expression block 260, and/or the IP address block 265.

The query parser 235 receives the search query from the search interface 215 and converts that query into the primary structured query using the tokenizer 250. The tokenizer 250 of the query parser 235 breaks or tokenizes the search query and particularly, the characters of the search query, into a plurality of tokens. For each token, the tokenizer 250 parses that token into recognized keywords, expressions, and/or IP addresses. The tokenizer 250 may communicate with the keyword block 255, the expression block 260, and the IP address block 265 to parse the search query. The tokenizer 250 may also convert any “human-friendly” terms in the search query into recognized keywords. Further, although not shown, in some embodiments, the tokenizer 250 may also include or be in communication with additional components such as a ranking block to rank the identified keywords, a relationship block to identify relationships between the keywords, a matching block to match keywords and assign scores, etc. to facilitate conversion of the search query into the primary structured query.

Based upon the information obtained by the tokenizer 250, the tokenizer parses the search query and converts the search query into the primary structured query. Each primary structured query identifies one or more primary entity types and/or one or more entities from the search query. If the search query is not indicative of an entity type and/or a particular entity, the tokenizer 250 may designate a default primary entity type and/or entity. Further, for each identified primary entity and/or entity type, the primary structured query also identifies one or more primary activity types from the search query. In some embodiments, the primary activity types may include, for example, keywords associated with actions, properties, and identifiers, as discussed above. The primary activity types may also include alerts arising from the identified entity and/or entity type. In other embodiments, additional, fewer, or other primary activity types may be defined for each entity and/or entity type. Further, the primary activity types associated with a particular primary entity and/or entity type may be different from the primary activity types associated with another primary entity and/or entity type. The primary activity types for each primary entity and/or entity type may be configurable and may be user or system defined. If the search query is not indicative of a primary activity type, the tokenizer 250 may designate a default primary activity type.

As an example of the primary structured query, if the search query input by the user is “V1 latency,” the tokenizer 250 may first tokenize the search query into two tokens, for example, a first token “V1” and a second token “latency.” For each token, the tokenizer 250 may access one or more of the keyword block 255, the expression block 260, the IP address block 265, and any other information that the tokenizer accesses to identify whether that token corresponds to a property such as a metric, an identifier such an entity name, an alert, etc. The tokenizer may further associate an entity and/or entity type with the identified property, identifier, alert, etc. Thus, the tokenizer 250 not only identifies the various keywords associated with each token, the tokenizer also identifies the category of those keywords.

For example, for the first token, “V1,” the tokenizer 250 may reference one or more of the keyword block, 255, the expression block 260, the IP address block 265, and any other information that the tokenizer has access to, and determine that the first token is likely an identifier (e.g., name) associated with a particular entity and/or entity type. Specifically, the tokenizer 250 may find references (e.g., by word matching and/or other mechanism) of “V1” within the keyword block 255, the expression block 260, the IP address block 265, etc. to identify all components that have “V1” as part of a keyword. For example, the tokenizer 250 may find that “V1” appears in the names of a specific cluster, a specific virtual machine, and a specific virtual disk. The tokenizer 250 may associate the cluster, virtual machine, and virtual disk that have “V1” in their names with the first token. Thus, the tokenizer 250 has identified one or more entities and/or entity types for the first token. These identified one or more entities and/or entity types correspond to the primary entities and/or entity types within the primary structured query.

Along with parsing the first token or after parsing the first token, the tokenizer 250 may parse the second token, “latency” in the search query “V1 latency.” Again, the tokenizer 250 may access the keyword block 255, the expression block 260, the IP address block 265, etc. to find (e.g., by word matching and/or other mechanism) references to “latency.” The tokenizer 250 may determine that “latency” is a keyword associated with a metric. As discussed above, metrics may also be classified as an activity type. Thus, the tokenizer 250 associates “latency” in the second token with the primary activity type in the primary structured query.

Thus, a search query, which may include a set of keywords, expressions, IP addresses, “human-friendly” words, or a combination thereof, may be interpreted in multiple ways by the tokenizer 250 to generate the primary structured query. Each primary structured query may include a combination of one primary entity or entity type and one primary activity type. Thus, for multiple primary entity or entity types and/or for multiple primary activity types identified by the tokenizer 250 during the parsing operation, multiple primary structured queries may be generated. For example, if the tokenizer 250 identified a specific virtual disk and a specific virtual machine associated with the first token, “V1” in the search query “V1 latency,” one structured query may be <Entity Type (Virtual Machine), Entity (V1), Activity Type (latency)> and another structured query may be <Entity Type (Virtual Disk), Entity (V1), Activity Type (latency).” In other embodiments, a single structured query may be generated for all of the entity types. In such embodiments and for first token, “V1” identified as a specific virtual machine and a specific virtual disk, the structured query may look like <Entity Type (Virtual Machine or Virtual Disk), Entity (V1), Activity Type (latency)>.

It is to be understood that the format of the primary structured queries shown and described above is simply an example for purposes of explanation. The format of the primary structured queries may vary from one embodiment to another based upon the configuration of the search computing system 200. Further, it is to be understood that the search query “V1 latency” discussed above is also only an example for purposes of explanation. The search queries input by the user may take a variety of forms, as discussed above. Further, the search queries may include a single term or more than two terms in other embodiments. Thus, the tokenizer 250 is configured to receive and analyze search queries having a single token or greater than two tokens. Also, the actual format of the search queries, the format of the structured queries, the order in which the tokens are analyzed, etc. may vary from one embodiment to another. In some embodiments and particularly for more complex search queries, the tokenizer 250 may rank various tokens, generate token chains, etc., as described in greater detail in U.S. application Ser. No. 15/143,060, again, the entirety of which is incorporated by reference herein. Thus, the tokenizer 250 may generate one or more primary structured queries from each search query run by the user.

Each primary structured query generated by the tokenizer 250 provides a framework to the primary result generator 245 for retrieving the primary search results. Each primary structured query may also be stored within a structured query database 270 for future usage and reference. Although shown as a separate database, in some embodiments, the structured query database 270 may be part of the storage pool 140, the keyword block 255, the expression block 260, the IP address block 265, and/or another database within the search computing system 200. Each primary structured query may also be provided to the primary result generator 245. Although the primary result generator 245 is shown as receiving the primary structured query from the structured query database 270, in some embodiments, the primary result generator may receive the primary structured query directly from the tokenizer 250.

The primary result generator 245 may be configured to access the storage pool 140, as well as any other database accessible to the primary result generator to gather primary search results corresponding to the primary structured query. For example, for the primary structured query of <Entity Type (Virtual Machine), Entity (V1), Activity Type (latency)>, the primary result generator 245 may access the virtual machine, V1, and gather the latency related data therefrom. Thus, for each primary structured query generated from a search query, the primary result generator 245 gathers the associated data. The primary result generator 245 may also aggregate and sort the gathered results and return those results to the search interface 215 for displaying within the search display box 230.

Each primary structured query may also be provided to the subquery search system 210. Although the subquery search system 210 is shown as receiving the primary structured query from the structured query database 270, in some embodiments, the subquery search system may receive the primary structured query directly from the tokenizer 250 and/or the primary result generator 245. In some embodiments, the search computing system 200 may be configured such that the search query input by the user in the search box 225 is provided to the query parser 235 as well as the subquery search system 210. In such embodiments, the subquery search system 210 may be configured with its own query parser that parses the search query and generates one or more primary structured queries therefrom for its own use.

By providing the search query to the subquery search system 210, the subquery search system and the query parser 235 may work simultaneously to gather search results faster. Thus, providing an instance of the query parser within the subquery search system 210 may improve the overall performance of the search computing system in that search results may be returned faster to the user. However, the performance benefits may come at an increased complexity and cost of the search computing system 200. Thus, based upon the requirements of the search computing system 200, the subquery search system 210 may be configured with its own query parser or the subquery search system may receive the structured queries from the query parser 235.

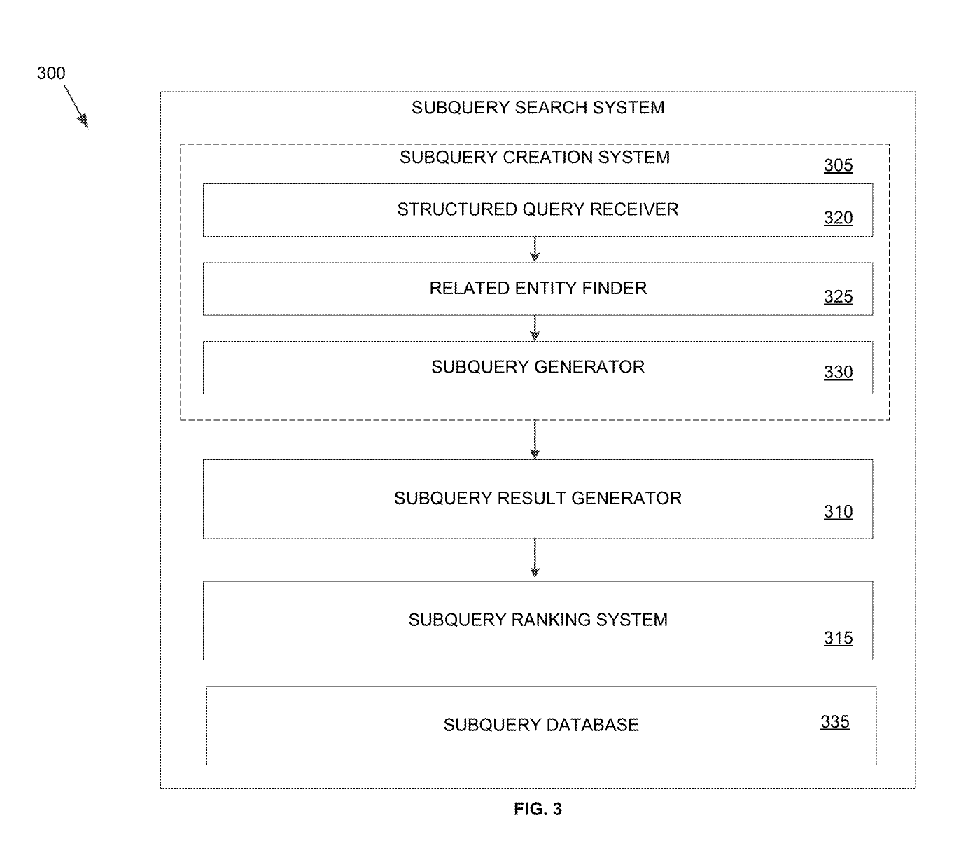

The subquery search system 210 may use the primary structured query to generate subqueries, also referred to herein as secondary structured queries. To generate subqueries, the subquery search system 210 may identify related entities and/or entity types for each primary entity and/or entity type identified in the primary structured query. The subquery search system 210 may also identify the primary activity type from the primary structured query and associate the primary activity type with each of the related entities and/or entity types to generate one or more subqueries. The generation of subqueries from primary structured queries is explained with respect to FIGS. 3-6 below. The subquery search system 210 may also retrieve related search results for each of the generated subqueries and return those results to the search interface 215 for displaying within the search display box 230. Thus, each search query may generate one or more primary structured queries and one or more subqueries.

Although not shown, in some embodiments and as discussed above, the primary search results and the related search results may be ranked and/or combined before being displayed in the search display box 230. In some embodiments, the combined search results may also be ranked before being returned to the search interface 215. Thus, primary search results, related search results, and/or combined search results may be returned to the search interface 215 for display within the search display box 230.

In some embodiments, the search display box 230 may be divided into various boxes, such as a summary box 275, a primary results box 280, a related results box 285, other information box 290, and a help box 295. The summary box 275 may display an overall summary of the primary search results and the related search results, the primary results box 280 may display the primary search results received from the primary result generator 245, the related results box 285 may display the related search results received from the subquery search system 210, the other information box 290 may list any other pertinent data that may have been uncovered during the search, and the help box 295 may include resources that help the user understand various search results, configure the search display box 230, and/or aid with other search related functionality.

Further, the results displayed within each of the summary box 275, the primary results box 280, the related results box 285, and the other information box 290 may or may not be interactive. If interactive, the user may interact with (e.g., click) a particular item within those boxes to view/access additional information related to that item. Some of the boxes may be empty if there are no results to display.

Furthermore, in some embodiments, the configuration of the search display box 230 may change based upon the which search results are to be displayed. For example, when combined search results are desired, as indicated above, a configuration setting that may be user or system defined may be used to generate combined search results by combining the primary search results with the related search results. Along with generating combined search results, the search computing system 200 may also simultaneously configure the search display box 230 to display the combined search results (e.g., by generating a separate combined search results box). In some embodiments, the search computing system 200 may configure the search display box 230 to display the combined search results within the other information box 290.

Similarly, if only the primary search results and the combined search results are desired to be displayed within the search display box 230, the search computing system 200 may be configured to disable or remove the related results box 285 and provide a combined search box (or use the other information box 290). Thus, the configuration of the search display box 230 may vary based upon the search results that are desired to be displayed.

Thus, although the summary box 275, the primary results box 280, the related results box 285, the other information box 290, and the help box 295 are shown herein, in other embodiments, additional, fewer, or different boxes may be displayed. Further, in some embodiments, the number and types of boxes, as well as the shape, size, arrangement, and other configuration of the boxes that are displayed within the search display box 230 may vary in other embodiments. Further, the information displayed within each of the boxes may vary from one embodiment to another.

Referring now to FIG. 3, a block diagram of a subquery search system 300 is shown, in accordance with some embodiments of the present disclosure. The subquery search system 300 is analogous to the subquery search system 210. As indicated above, the subquery search system 300 is configured to generate one or more subqueries from each primary structured query, which in turn is created from a search query run by the user on the search interface 215. The subquery search system 300 includes a subquery creation system 305, a subquery result generator 310, and possibly a subquery ranking system 315. The subquery creation system 305 is configured to generate one or more subqueries from a primary structured query using a structured query receiver 320, a related entity finder 325, and a subquery generator 330. The generated subqueries may be stored within a subquery database 335.

The structured query receiver 320 is configured to receive the primary structured queries from the structured query database 270, the query parser 235, and/or the primary result generator 245. In some embodiments, as discussed above, the subquery search system 300 may directly receive the search query run by the user and generate a primary structured query itself. The structured query receiver 320 may parse the primary structured query to identify one or more primary entities and/or entity types from the primary structured query. The structured query receiver 320 may also parse the primary structured query to identify one or more primary activity types from the primary structured query. The structured query receiver 320 may provide the identified primary entities and/or entity types to the related entity finder 325, and the identified one or more primary activity types to the subquery generator 330.

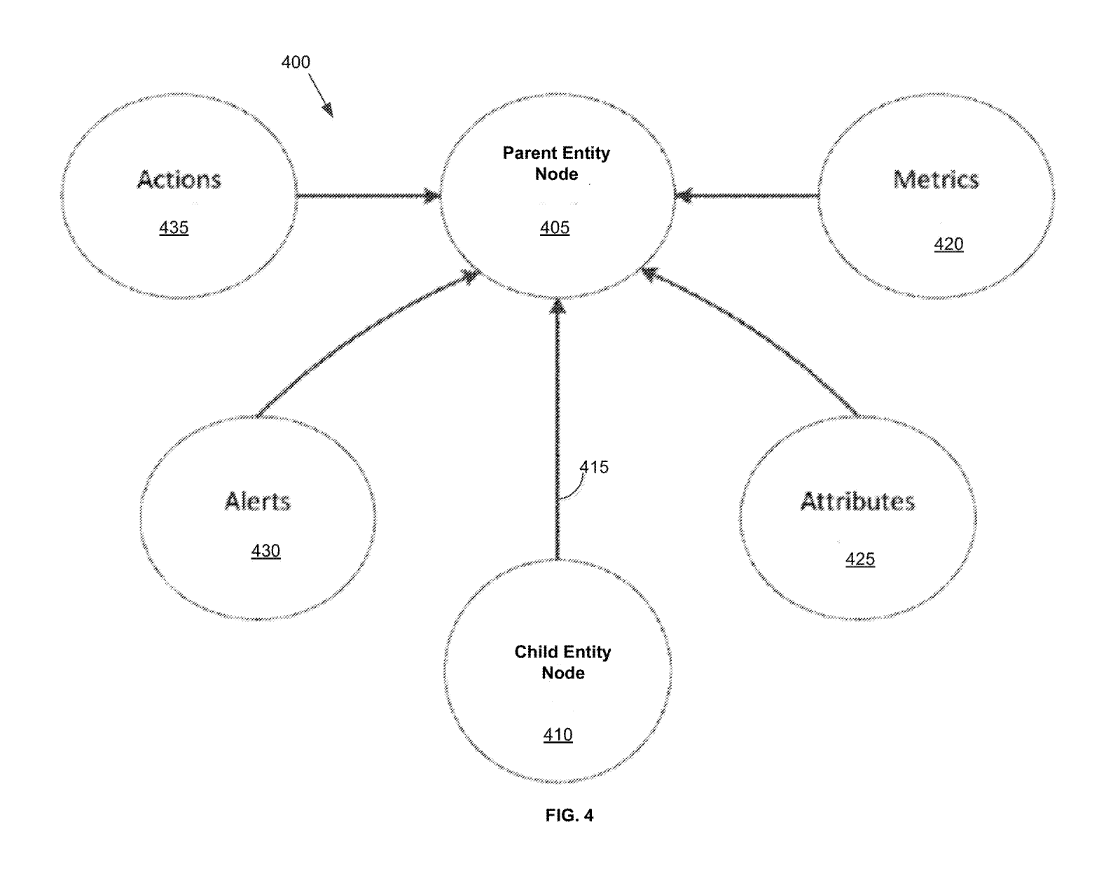

The related entity finder 325 may identify related entities and/or entity types corresponding to the primary entities and/or entity types. To determine the related entities and/or entity types, the related entity finder 325 may analyze one or more entity relationship graphs. Examples of entity relationship graphs are shown in FIGS. 4-6.

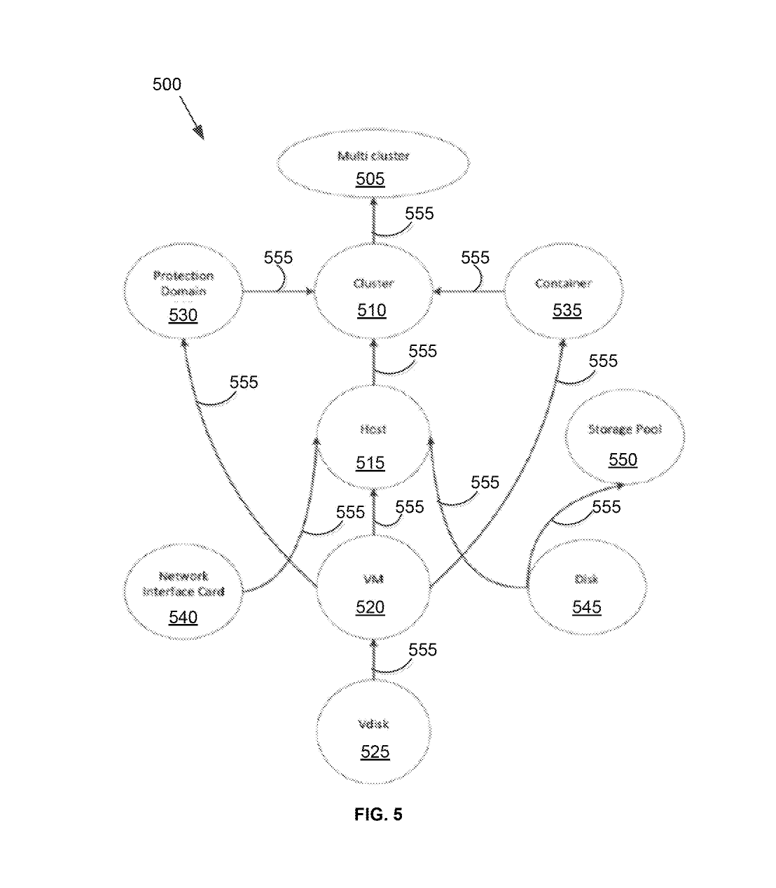

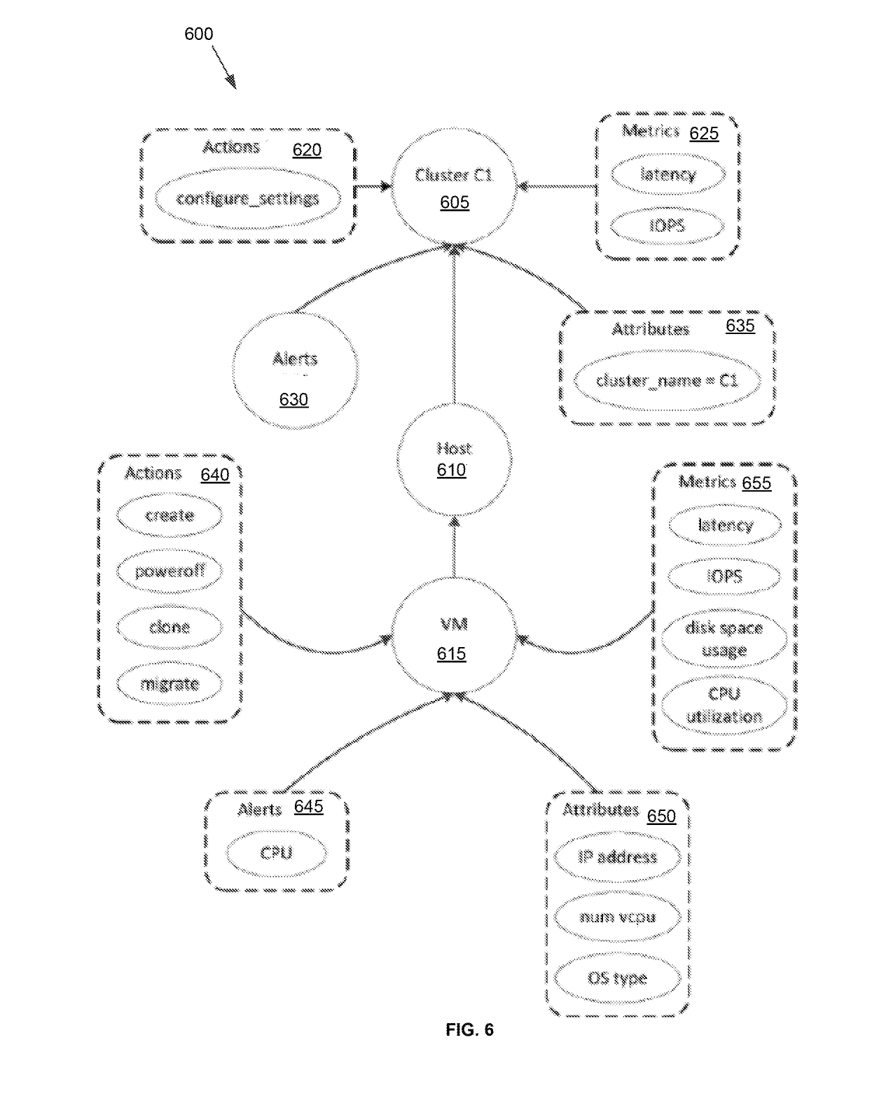

Referring to FIG. 4 in conjunction with FIG. 3, an entity relationship graph 400 is shown, in accordance with some embodiments of the present disclosure. The entity relationship graph 400 shows only the basic components that make up an entity relationship graph. FIGS. 5 and 6 provide more detailed examples of the entity relationship graph. The basic components of the entity relationship graph 400 are entity nodes and activity nodes. Entity nodes correspond to various entities within or associated with virtual computing system 100. An “entity” is any component within or associated with the virtual computing system 100 that is configured to be queried. All entities of the same kind may be classified as a particular “entity type.”

The various entities and entity types are related to one another in a hierarchical relationship. For example, all entity types may be related either in a parent-child relationship. Likewise, all entities of a particular entity type may be related in a sibling relationship. Thus, the entity relationship graph 400 is organized in a tree-like structure with entity nodes connected to one another via links. Each entity node within the entity relationship graph 400 may be a parent node or a child node, and/or a sibling node. Each entity node has a single parent node, although some entity nodes (e.g., the nodes that are at the top of chain) may have no parent nodes. Also, a parent node may have multiple child nodes. For example, multiple host machines may exist within a cluster. Thus, the cluster may be a parent node and all of the host machines may be child nodes. In other words, each host machine has a single parent node—the cluster, while the cluster has multiple child nodes (e.g., the host machines).

Further, all nodes on the same level of the tree structure are siblings. Thus, all host machines that are connected to the same cluster are siblings. In sum, for a host machine-cluster example, each host machine is a sibling to another host machine, as well as a child to the cluster. Similar parent-child and sibling relationships may exist between other components of the virtual computing system 100.

The entity relationship graph 400 shows a simplified parent-child relationship structure with two entity nodes: a single parent node and a single child node. For example, the entity relationship graph 400 shows that an entity node 405 is related to entity node 410 in a parent-child relationship, with the entity node 405 being a parent node and the entity node 410 being a child node. Direction of arrow 415 connecting the entity node 405 to the entity node 410 indicates a parent-child relationship (e.g., the arrow goes from the child node to the parent node). Although not shown, the entity node 405 may be connected to one or more additional child entities, each of which along with the entity node 410 would be sibling nodes of one another. Likewise, the entity node 405 may be a child node to another parent node, and the entity node 410 may be a parent node to other child(ren) node.

Further, as indicated above, each node in the entity relationship graph 400 may have one or more activity nodes associated therewith. Activity nodes are different from entity nodes. While the entity nodes represent the various entities within the virtual computing system 100, the activity nodes identify various attributes, actions, metrics, alerts, and other relevant information associated with a particular entity. Generally speaking, each entity node (e.g., the entity node 405 and the entity node 410) within the entity relationship graph 400 includes at least one activity node, although this need not always be the case. In some embodiments, the entity nodes (e.g., the entity node 405 and the entity node 410) may have no activity nodes associated therewith.

The entity relationship graph 400 shows an example of the activity nodes for the entity node 405. The entity node 405 is shown to have associated therewith four activity nodes, including a metrics node 420, an attributes node 425, an alerts node 430, and an actions node 435. Metrics, alerts, attributes, and actions are all keywords discussed above. Thus, the metrics node 420 may aggregate metrics related information for the entity node 405, the attributes node 425 may aggregate other property and identifier related information associated with the entity node 405, the alerts node 430 may collect all alerts arising from the entity associated with the entity node 405, while the actions node 435 may indicate what actions the entity node 405 may perform. Thus, the activity nodes correspond to the various categories of keywords discussed above, and each activity node may correspond to one or more categories of the keywords.

Although four activity nodes are shown associated with the entity node 405, in other embodiments, additional, fewer, or different activity nodes may be associated with the entity node 405. Similarly, although the entity node 410 is not shown as having any activity nodes, in other embodiments, the entity node 410 may also have one or more activity nodes. Generally speaking, the number and type of activity nodes associated with each entity within the entity relationship graph 400 may depend upon the entity type. For example, a node of entity type “cluster” may have different activity nodes than a node of entity type “virtual disk.” Thus, the activity nodes of each entity may vary from one embodiment to another based upon the configuration of the virtual computing system 100.

Further, it is to be understood that the entity relationship graph 400 is shown with only two entity nodes (e.g., the entity node 405 and the entity node 410) to simply explain the basic components of an entity relationship graph. In other embodiments, the entity relationship graph may include several entity nodes (or possibly a single entity node), with each entity node having one or more activity nodes (or possibly no activity nodes) depending upon the configuration of the virtual computing system 100. Moreover, in some embodiments, the components of the virtual computing system 100 may be broken down into subsets and each subset may be configured as an entity relationship graph. The entity relationship graphs of such subsets may or may not be connected to one another. Furthermore, the entity relationship graph 400 may be stored as part of the storage pool 140, part of a database within the search computing system 200, or another database or cloud accessible to the subquery search system 300.

Turning now to FIG. 5 and referring to FIG. 5 in conjunction with FIGS. 3 and 4, another example of an entity relationship graph 500 is shown, in accordance with some embodiments of the present disclosure. The entity relationship graph 500 shows multiple entity nodes connected in a hierarchical parent-child relationship. For example, the entity relationship graph 500 shows a multi cluster node 505, a cluster node 510, a host node 515, a virtual-machine node 520, a virtual-disk node 525, a protection-domain node 530, a container node 535, a network interface card node 540, a disk node 545, and a storage pool node 550 connected in a parent-child relationship. It is to be understood that the various nodes shown in FIG. 5 are simply an example of the entity types that may be found within the virtual computing system 100. Depending upon the components of the virtual computing system 100 and how those components are connected to each other, the entity nodes and the relationship between the entity nodes may vary from one embodiment to another.

As shown in FIG. 5, the multi cluster node 505 is representative of all the clusters that may make up the virtual computing system 100. For example, if the virtual computing system 100 includes five clusters, the multi cluster node 505 represents all of the five clusters. Thus, each of the five clusters may be individually represented by an instance of the cluster node 510. Thus, the multi cluster node 505 and the cluster node 510 are connected in a parent-child relationship, with the multi cluster node being the parent node and the cluster node being the child node. Similarly, each of the cluster node 510 may be connected in a parent-child relationship to one or more of the host node 515, only one of which is shown herein. The host node 515 is representative of a host machine. Since each cluster may include one or more host machines, an instance of the host node 515 may be provided for each of those host machines. The cluster node 510 would then be the parent node and the host node 515 would be the child node.

Similar parent-child relationships, all of which are not described here individually, exist between the other nodes shown in FIG. 5. Generally speaking, a parent-child relationship between two entity nodes may be ascertained by looking at the direction of link or arrow 555 connecting two entity nodes. The head of the arrow 555 points to the parent. Thus, the arrow 555 leads from the child entity node to the parent entity node.

Further, certain entity nodes may not be related directly to one another but may be related indirectly via another entity node. For example, the virtual-machine node 520, which corresponds to a virtual machine, is not directly connected to the cluster node 510. However, the virtual-machine node 520 is indirectly connected to the cluster node 510 via the host node 515. Thus, the cluster node 510 and the virtual-machine node 520 may be said to be in a grandparent-grandchild relationship. Therefore, from the entity relationship graph 500, the relationships between various entity nodes may be ascertained. As also discussed above, each entity node may have associated therewith one or more activity nodes. The entity relationship graph 500 does not show any activity nodes for simplicity of explanation. However, FIG. 6 shows a portion of the entity relationship graph 500 in which certain entity nodes are shown with one or more activity nodes.

Although a single instance of each of the multi cluster node 505, the cluster node 510, the host node 515, the virtual-machine node 520, the virtual-disk node 525, the protection-domain node 530, the container node 535, the network interface card node 540, the disk node 545, and the storage pool node 550 are shown in FIG. 5, in other embodiments, multiple instances of one or more of those nodes depending upon the configuration of the virtual computing system 100 may be present. Further, in some embodiments, not all of the entity nodes that are shown in FIG. 5 may be present. Again, the entity nodes that are provided within the entity relationship graph 500 and the relationship between those entity nodes may vary based upon the components present within the virtual computing system 100 and the relationship between those components.

Referring to FIG. 6 in conjunction with FIGS. 3-5, an entity relationship graph 600 is shown, in accordance with some embodiments of the present disclosure. The entity relationship graph 600 includes both entity nodes and activity nodes. For example, the entity relationship graph 600 shows a cluster node 605, a host node 610, and a virtual machine node 615—all of which are entity nodes. The entity relationship graph 600 also includes activity nodes. For example, the cluster node 605 is shown to have an actions node 620, a metrics node 625, an alerts node 630, and an attributes node 635—all of which are activity nodes. In other embodiments, the cluster node 605 may have fewer, additional, or different activity nodes. Further, it is to be understood that the features noted in the each of the activity nodes in FIG. 6 are simply an example. In other embodiments, the features within each activity node may vary.

Similarly, although the virtual machine node 615 is shown to have four activity nodes including an actions node 640, an alerts node 645, an attributes node 650, and a metrics node 655, in other embodiments, the virtual machine node may have fewer, additional, or different activity nodes. Also, although the host node 610 is not shown as having any activity nodes, in other embodiments, the host machine node may be configured with one or more activity nodes. Likewise, any other entity nodes within the entity relationship graph 600 may include one or more activity nodes.

By reviewing and/or analyzing the activity nodes associated with a particular entity node, additional information pertaining to that entity node may be gleaned. For example, by looking at the actions node 620 of the cluster node 605, it may be determined what actions the cluster associated with the cluster node 605 may perform. For example, as noted in the actions node 620, the cluster associated with the cluster node 605 may configure settings of the cluster and possibly of the various components within the cluster. Similarly, as noted by the actions node 640 of the virtual machine node 615, the virtual machine associated with the virtual machine node may take various actions related to creating, powering-off, cloning, and migrating.

Likewise, the alerts node 645 of the virtual machine node 615 lists the various alerts that are being raised by the virtual machine associated with the virtual machine node. For example, the alerts node 645 of the virtual machine node 615 shows a CPU related alert being issued from the virtual machine associated with the virtual machine node. In some embodiments, the alerts node 645 may be configured to show only those alerts that are currently being raised by the associated entity. In other embodiments, the alerts node 645 may be additionally or alternatively configured to show alerts that were raised previously within a given amount of time. Further, in some embodiments, the alerts node 645 may only show what alerts are being raised by the associated entity, but may not show any additional details associated with that alert. In other embodiments, the alerts node 645 may also show the additional details associated with the alerts. For example, the alerts node 645 shows a CPU related alert. In some embodiments, the alerts node 645 may also show what type of CPU alert (e.g., related to utilization, latency, etc.) is being raised and the values associated with that alert.

The alerts node 630 of the cluster node 605 is shown as being empty. This may suggest that no alerts are being issued currently by the associated cluster or that no alerts have been issued by the cluster in a predetermined period, as the case might be based upon the configuration of the alerts node. Thus, as noted above, the activity nodes may be configurable. Similar to the alerts node 630 and 645, the other activity nodes may be configurable. For example, as the actions that an associated entity may make are varied, the actions node may be varied to correctly reflect those actions. Thus, by reviewing the information within the activity nodes, various kinds of information pertaining to the associated entity may be easily determined.

Returning back to FIG. 3, for purposes of generating subqueries, the related entity finder 325 identifies the related entities of each primary entity identified in the primary structured query by the structured query receiver 320. The related entity finder 325 thus refers to the entity relationship graph 500 to identify the related entities. What constitutes a “related entity” may vary from one embodiment to another. In some embodiments, a related entity may be one that is directly connected to the primary entity in the entity relationship graph. In some embodiments, the direct connection relationship may be further limited to only parent-child relationships, only sibling relationships, or both. In other embodiments, a related entity may be one that is removed from the primary entity by a given number of nodes. For example, in some embodiments, nodes separated by another node in between (e.g., in a grandparent-grandchild relationship) may be considered for finding related entities. In other embodiments, greater separation of nodes may be considered for finding related entities. Thus, what constitutes a related entity may vary from one embodiment to another.

Further, the definition of a related entity may be system defined and/or user defined. For example, in some embodiments, the user running the search query may be allowed to define what entities are considered to be related. In other embodiments, the subquery search system 300 or any other component within the virtual computing system 100 may define what entities are considered to be related. Based upon the definition of the related entities, the related entity finder 325 finds the related entities of each primary entity in the primary structured query from the entity relationship graph 500. For example, in the example discussed above in which the search query “V1 latency” is transformed into a primary structured query <Entity Type (Virtual Machine), Entity (V1), Activity Type (latency)> and <Entity Type (Virtual Disk), Entity (V1), Activity Type (latency)>, the related entity finder 325 finds related entities of both the V1 virtual machine and the V1 virtual disk.

Specifically, the related entity finder 325 may access the entity relationship graph 500 and find the entity node that corresponds to the V1 virtual machine. In some embodiments, the related entity finder 325 may identify the entity node corresponding to the V1 virtual machine by reviewing the attributes (or other activity nodes) associated with the various entity nodes and searching for a virtual machine having an attribute (e.g., name) of V1. The entity node corresponding to that activity node is then the entity node for the V1 virtual machine. After identifying the V1 virtual machine in the entity relationship graph 500, the related entity finder 325 may look for the entity nodes connected to the V1 virtual machine and that satisfy the definition of a related entity. For example, if the related entities are limited to siblings and parent of the V1 virtual machine, the related entity finder 325 may find other virtual machines connected to the V1 virtual machine in a sibling relationship (e.g., all siblings share the same parent node). The related entity finder 325 may also determine a host machine entity node as a parent node of the V1 virtual machine. Similarly, from the entity relationship graph 500, the related entity finder 325 may find the related entities for the V1 virtual disk.

In some embodiments, the definition of a related entity may vary based upon the entity type. For example, in some embodiments, the definition of a related entity for a cluster may be different from the definition of a related entity for a virtual machine, and so on. Upon gathering all of the related entities corresponding to the primary entity, the related entity finder 325 may provide the list of related entities to the subquery generator 330.

For each related entity, the subquery generator 330 generates one subquery. Specifically, the subquery generator 330 may associate each related entity with the primary activity type identified in the primary structured query to generate a subquery. For example, for the primary structured query <Entity Type (Virtual Machine), Entity (V1), Activity Type (latency)> in which the related entity finder 325 has identified a related entity, V2 virtual machine, the subquery generator 330 may generate a subquery such as <Entity Type (Virtual Machine), Entity (V2), Activity Type (latency)>. Again, the format of the subquery is simply an example and may vary in other embodiments. Also, in some embodiments, the format of a subquery may be the same or similar as, or different from the format of a primary structured query. The subqueries may be stored within the subquery database 335, as well as provided to the subquery result generator 310.

The subquery result generator 310 may be configured similar to the primary result generator 245 in that the subquery result generator may access the various databases within the virtual computing system 100 to gather the related search results from the related entities identified in the subqueries. Further, in some embodiments, the subquery result generator 310 may gather search results from the related entities corresponding to the same activity type identified in the primary structured query. In other embodiments, the subquery result generator 310 may additionally or alternatively gather search results from other activity types of the related entities. Although the subquery result generator 310 and the primary result generator 245 are shown as different components herein, in other embodiments, the subquery result generator and the primary result generator may be combined together into a single component. Further, the related search results gathered by the subquery result generator 310 may optionally be ranked within the subquery ranking system 315, as discussed above.

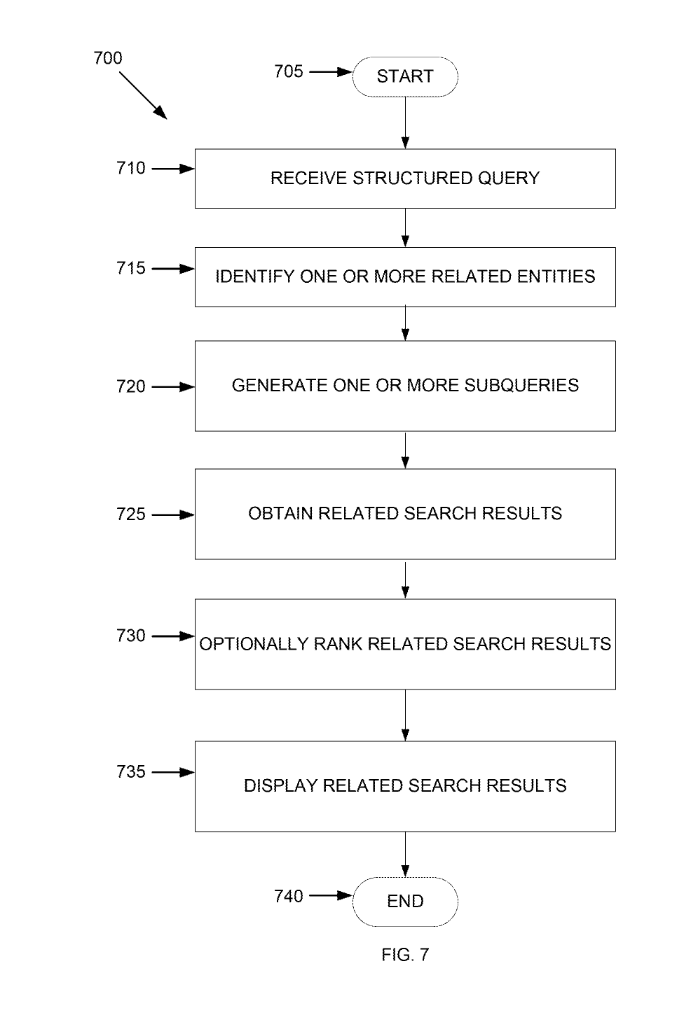

Turning now to FIG. 7, a flowchart outlining a process 700 for generating related search results is shown, in accordance with some embodiments of the present disclosure. The process 700 may include additional, fewer, or different operations, depending on the particular embodiment. After starting at operation 705, the subquery search system 300 receives a primary structured query at operation 710. As discussed above, the structured query receiver 320 receives the primary structured query and parses the primary structured query to identify a primary entity and a primary activity type from each primary structured query. In some embodiments, the subquery search system 300 may directly receive the search query run by the user and generate the primary structured query.

At operation 715, the related entity finder 325 identifies one or more related entities from each primary entity. At operation 720, the subquery generator 330 associates each related entity with the primary activity type to generate a subquery. Thus, from one primary structured query, depending upon the number of related entities, multiple subqueries may be generated. In some embodiments, such multiple subqueries may be combined into a single subquery. Using the generated subqueries, related search results are gathered at operation 725 by the subquery result generator 310 and the gathered results may be ranked by the subquery ranking system 315 at operation 730. The related search results, whether ranked or unranked, are sent to the search interface 215 for displaying within the search display box 230 at operation 735. The process 700 ends at operation 740.

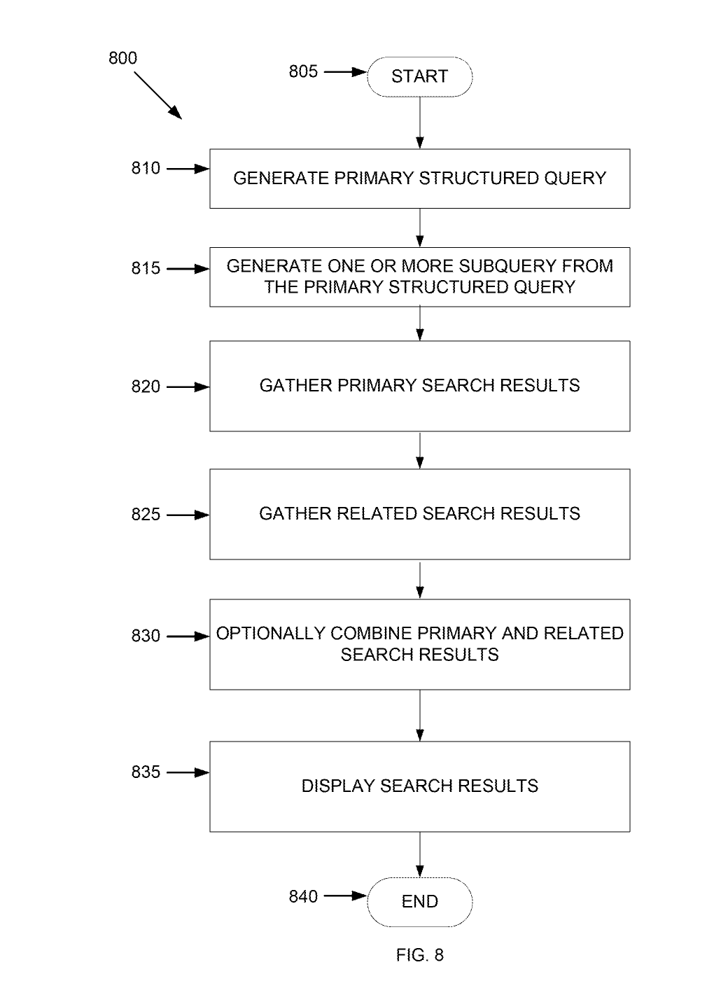

Turning now to FIG. 8, a flowchart outlining a search process 800 is shown, in accordance with some embodiments of the present disclosure. The search process 800 may include additional, fewer, or different operations, depending on the particular embodiment. After starting at operation 805, the search computing system 200 receives a search query from the user. The search query is used to generate a primary structured query at operation 810. As discussed above, the search query may be provided to a query parser 235, which generates the primary structured query. In some embodiments, the search query may also be provided to the subquery search system 210 for generating the primary structured query (e.g., by providing an instance of the query parser 235 within the subquery search system as well). In such cases, both the query parser 235 and the subquery search system 210 may generate the primary structured query. Although repetitive, the simultaneously generation of the primary structured query may result in a faster retrieval of search results. Alternatively, in some embodiments, the search query may be transferred only to the subquery search system 210, which may generate the primary structured query and transmit the primary structured query to the structured query database 270, as well as the primary result generator 245. In such cases, the query parser 235 may only be needed within the subquery search system 210.

At operation 815, one or more subqueries may be generated by the subquery search system, as discussed above in FIG. 7. At operation 820, the primary search results are gathered and at operation 825, the related search results are gathered. It is to be understood that the operation 820 of gathering primary search results may occur simultaneously with generating the subqueries. If the primary and related search results are desired to be combined, at operation 830, the results are combined, and the combined search results may optionally be ranked. As discussed above, in some embodiments, the primary search results and the related search results may also be ranked individually. The primary search results, the related search results, and/or the combined search results are displayed within the search display box 230 at operation 835. The search process 800 ends at operation 840.

Thus, the present disclosure provides a system and method for generating subqueries from a primary structured query based upon search queries run by a user. The subqueries are designed to gather search results from related entities to increase the relevancy and effectiveness of a primary search operation. By using subqueries, troubleshooting, work flow, exploration, or other related tasks may be performed quicker and with ease.

Although the present disclosure has been described with respect to software applications, in other embodiments, one or more aspects of the present disclosure may be applicable to other components of the virtual computing system 100 that may be suitable for real-time monitoring by the user.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
receiving, by a virtual computing system, a search query via a search interface;
converting, by the virtual computing system, the search query into a primary structured query that identifies a primary entity within the virtual computing system and an activity type associated with the primary entity;
generating, by the virtual computing system, a subquery from the primary structured query, including associating the activity type of the primary entity with the subquery, wherein the subquery identifies a related entity of the primary entity; and
generating, by the virtual computing system, search results from the primary entity and the related entity corresponding to the activity type for displaying on the search interface.

2. The method of claim 1, wherein generating the subquery comprises identifying the related entity from an entity relationship graph that comprises a plurality of entity nodes arranged in a hierarchical relationship, and wherein two adjacent entity nodes of the plurality of entity nodes are associated in one of a parent-child relationship and a sibling relationship.

3. The method of claim 2, wherein the related entity and the primary entity are part of the plurality of entity nodes and connected in the parent-child relationship.

4. The method of claim 2, wherein the related entity and the primary entity are part of the plurality of entity nodes and connected in the sibling relationship.

5. The method of claim 2, wherein the virtual computing system identifies an activity node of a related entity node in the entity relationship graph for generating the search results, and wherein the related entity node corresponds to the related entity.

6. The method of claim 1, wherein the search results comprise primary search results generated from the primary structured query and related search results generated from the subquery.

7. The method of claim 6, further comprising ranking, by the virtual computing system, at least one of the primary search results and the related search results.

8. The method of claim 6, further comprising combining, by the virtual computing system, the primary search results and the related search results to obtain combined search results.

9. The method of claim 6, further comprising combining, by the virtual computing system, the primary search results and the related search results into combined search results, and ranking, by the virtual computing system, the combined search results.

10. The method of claim 6, further comprising displaying the primary search results and the related search results on the search interface.

11. A search system, comprising:
a subquery search system comprising:
a subquery database for storing a subquery; and
a subquery processing unit to:
identify a primary entity from a primary structured query, wherein the primary structured query is generated from a search query received via a search interface;
identify an activity type from the primary structured query;
determine a related entity of the primary entity;
generate the subquery from the related entity and the activity type;
store the subquery within the subquery database; and
generate related search results from the subquery.

12. The search system of claim 11, further comprising a primary search system comprising:
a structured query database for storing the primary structured query generated by the primary search system; and
a primary processing unit to:
receive the search query via the search interface;
parse the search query into the primary structured query;
store the primary structured query into the structured query database; and
generate primary search results based upon the primary structured query.

13.-14. (canceled)

15. The search system of claim 11, wherein the subquery processing unit accesses an entity relationship graph to identify the related entity, wherein the entity relationship graph comprises a plurality of entity nodes connected in a hierarchical relationship, and wherein each of the plurality of entity nodes represents a component within a virtual computing system that is configured to be queried.

16. The search system of claim 11, wherein the subquery processing unit ranks the related search results according to a predetermined criteria.

17. A method comprising:
receiving, by a subquery search system, a primary structured query from a primary search system;
identifying, by the subquery search system, a primary entity and an activity type from the primary structured query;
determining, by the subquery search system, a related entity of the primary entity;
generating a subquery from the related entity, including associating the activity type with the related entity in the subquery;
generating, by the subquery search system, related search results based upon the subquery; and
transmitting, by the subquery search system, the related search results for displaying on a search interface.

18. The method of claim 17, further comprising:
accessing, by the subquery search system, an entity relationship graph of the virtual computing system;
identifying, by the subquery search system, the primary entity in the entity relationship graph;
identifying, by the subquery search system, at least one entity related to the primary entity in the entity relationship graph and that satisfies a relation criteria; and
associating, by the subquery search system, the at least one entity as the related entity.

19. The method of claim 18, wherein the relation criteria comprises nodes in the entity relationship graph that are connected to the primary entity in at least one of a parent-child relationship and a sibling relationship.

20. The method of claim 17, further comprising ranking, by the subquery search system, the related search results before displaying on the search interface.

21. A non-transitory computer readable media with computer-executable instructions embodied thereon that cause a processor to perform a process comprising:
receiving a search query via a search interface;
identifying a primary entity and an activity type associated with the primary entity;
generating a subquery based upon a related entity of the primary entity, including associating the activity type of the primary entity with the subquery; and
generating search results from the primary entity and the related entity corresponding to the activity type for display on the search interface.

22. The non-transitory computer readable media of claim 21, further comprising identifying the primary entity and the related entity from an entity relationship graph.

23. The non-transitory computer readable media of claim 21, further comprising ranking the search results from the primary entity and the related entity.
